(19) United States
(12) Patent Application Publication
(10) Pub. No.: US 2005/0203259 A1
(43) Pub. Date: Sep. 15, 2005

(54) Method for reducing static charge and reactor fouling in a polymerization process

(76) Inventors: Kristen K. Poliafico, Mickleton, NJ (US); Michael Coyle, Williamstown, NJ (US); Matthew Marello, Collegeville, PA (US); Thomas M. Frantz, Arden, DE (US)

Correspondence Address: Matthew P. McWilliams;Buchanan Ingersoll PC, 14th Floor, 1835 Market Street, Philadelphia, PA, 19103-2985, US

(21) Appl. No.: 11/072,748

(22) Filed: Mar. 4, 2005

Related U.S. Application Data
(60) Provisional application No. 60/551,465, filed on Mar. 9, 2004.

(51) Int. Cl. C08F 2/00

(52) U.S. Cl. 526/74

(57) ABSTRACT

In the operation of a fluidized bed polymerization reactor, high levels of static can result in production interruptions due to reactor fouling and sheeting. Establishing an acceptable level of static in the reactor and controlling the static level as necessary can prevent significant reactor downtime. The present invention utilizes multiple dosing levels of a static inhibitor to eliminate and then maintain acceptable static levels in the reactor. The static inhibitor is injected directly into the cycle gas flow of the reactor resulting in rapid static dissipation.

### REFERENCE TO RELATED APPLICATIONS

This application claims priority under 35 U.S.C. § 119(e) to Provisional Patent Application Ser. No. 60/551,465, filed on Mar. 9, 2004, the contents of which are hereby included by reference in their entirety.

### FIELD OF THE INVENTION

The invention relates to processes for the production of polypropylene homopolymer, and propylene ethylene random copolymer. Specifically, the current invention relates to a method for reducing static charge and reactor fouling in a polymerization process.

### BACKGROUND

In polymerization processes using neat, non prepolymerized Ziegler-Natta catalyst systems, static can be present in the reactor during polymerization. Static can be generated from polar compounds present in the raw material streams, or by particle to particle friction within the reactor. The static can cause fine particles to agglomerate and adhere to the wall of the reactor. Because of the highly active catalyst present in the particulate fines, once adhered to the wall they will continue to react and cause large agglomerations or sheets of polymer to adhere to the wall of the reactor. Depending upon the kinetics of the particular Ziegler-Natta system, this sheeted polymer can then continue to grow, or fall from the wall plugging reactor outlet lines and creating processing problems and disrupted production.

Neutralizing the static generated by particle friction or polar compounds is integral in extending the production cycle of the fluidized bed reactor. The relationship between electrostatic charges and agglomeration and potential solutions in a process for production of polyethylene are discussed in U.S. Pat. No. 4,532,311 to Fulks et al.

Dissipation of static in the polymerization of propylene and ethylene utilizing water addition into the circulating gases has been disclosed in U.S. Pat. No. 6,111,034 to Goode et al.

U.S. Pat. No. 5,410,002 to Govoni et al discloses a gas phase polymerization process for the manufacture of homopolymers of ethylene or copolymers of ethylene with other alpha-olefins using a prepolymerized Ziegler-Natta type catalyst. Govoni et al discloses the addition of a polyfunctional amine compound to the polymerization process for the purpose of selectively inhibiting the polymerization of smaller particles. The polyfunctional amine compound in Govoni et al is maintained in a concentration of between 100 and 2000 ppm by weight relative to the polymer.

U.S. Pat. No. 6,335,402 to Mihan et al discloses a gas-phase reactor wherein the inner reaction zone of the reactor is coated with an antistatic coating comprising a poly-alpha-olefin and a non-volatile antistatic agent.

U.S. Pat. No. 6,469,111 to Mihan et al discloses a process for the gas-phase polymerization of alpha olefins using a catalyst containing anhydrous magnesium oxide and/or zinc oxide as an antistatic agent.

### SUMMARY OF THE INVENTION

The present invention provides a method for regulating static charge in a fluidized bed polymerization reactor comprising establishing an acceptable static charge level for a fluidized bed polymerization reactor, monitoring the static charge level in the polymerization reactor and adding an anti-static agent at a first concentration to the polymerization reactor in response to a static charge measurement outside the acceptable level to return the static measurement to the acceptable level. The anti-static agent is then added at a second concentration to stabilize the static measurement at the acceptable level. The preferred anti-static agent is a hydroxylethyl alkylamine or derivatives of hydroxyethyl alkylamine.

### BRIEF DESCRIPTION OF THE DRAWINGS

FIG. 1: illustrates the decrease in monitored static levels obtained from practicing the current invention in the production of polypropylene homopolymer.

FIG. 2: illustrates the decrease in monitored static levels obtained from practicing the current invention during the transition from the production of polypropylene homopolymer to random copolymer.

### DESCRIPTION OF THE INVENTION

The present invention provides a method for reducing static charge and reactor fouling in a polymerization process using a non-prepolymerized Ziegler-Natta catalyst in one or more fluidized bed reactors containing a heat exchanger to remove the heat of polymerization and a compressor to fluidize the polymer bed and circulate monomer through the bed.

The invention will be especially useful in the processes used for the production of polypropylene homopolymer and propylene ethylene random copolymer (between 0.1% and 6% ethylene) using a fluidized bed reactor containing a heat exchanger to remove the heat of polymerization and a compressor to fluidize the polymer bed and circulate monomer through the bed.

The invention achieves this result through the injection of a liquid antistatic, antifouling agent into the circulating gas of the polypropylene fluidized bed reactor. Preferred antifouling agents include the chemical derivatives hydroxylethyl alkylamine, available under the trade names ATMER® 163, ARMOSTAT® 400, or similar compound. The antistatic agent can be injected anywhere in the circulating gas line. The antistatic agent may be injected into the system neat, but is preferably added with a carrier to improve dispersion and make dosing easier. Carriers for the material can be any of the following feeds into the system, including propylene, nitrogen, hydrogen, electron donor. Preferably, the antistatic agent is injected into the electron donor stream as the carrier and is injected at a point in the cycle pipe downstream of the gas cooler.

According to an embodiment of the method of the current invention, static is measured using one or more static monitors placed in the fluidized bed reactor, preferably the lower ¼ of the straight side of the fluidized bed reactor. More preferably the method of the current invention utilizes two static probes, placed between 2 and 3 feet vertically apart on the same reactor plane. The static monitors can read volts or amps, although best operation is obtained using amps. When monitoring static, the raw reading, standard deviation from optimum or relative percentage of a set scale can be monitored.

During normal operation, static should be relatively low in the reactor and no antistatic agent is fed into the reactor. However, when a process upset occurs or a polar compound, catalyst poison, is present in one of the raw material streams, static will increase in amplitude and standard deviation. According to the invention, following the increase, antistatic agent is fed into the circulating gas line, generally at a value between 5 ppm and 100 ppm by weight based on polymer production to mitigate the static charge.

In an exemplary embodiment of the method according to the current invention, static charge in polymerization reactor is constantly monitored using at least one amp meter. The static charge is compared to an established scale, of −50,000 to +50,000 pico amps for instance, where a reading of 0 pico amps constitutes optimum operating conditions. A trigger point is set at a predetermined percent deviation from optimum conditions. For example a deviation of greater than ±20 percent, or ±10,000 pico amps from the zero optimum would trigger an addition of antistatic agent to the reactor to mitigate the static charge.

According to the exemplary embodiment, an antistatic agent is added at a constant rate and relatively high concentration, e.g. near 100 ppm by weight, until the measured charge returned to close to the operating optimum. Once the process is returned to within the trigger range, the rate of addition of the antistatic agent is reduced to closer to 5 ppm by weight to stabilize the static charge. Once the charge is stabilized the addition of antistatic agent is discontinued.

It will be recognized that the scale and trigger points established will depend on the particular polymerization process in which the method according to the current invention is implemented.

Addition of the antistatic agent can be performed manually by operators or can be accomplished by means of an automated on-line monitoring system.

### EXAMPLES

In order to provide a better understanding of the present invention, the following examples are used to illustrate the effectiveness of the static control system.

### Example 1

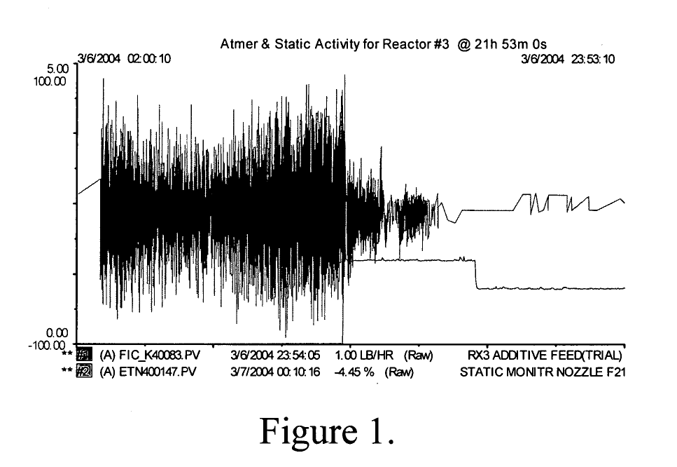

During the production of homopolymer polypropylene and following a reactor upset, elevated levels of carbon monoxide were present in the reactor. This resulted in high static levels within the reactor. The static varied from +/−90% of the targeted normal static level. Hydroxylethyl alkylamine was added to the reactor at a concentration of 30 ppm by weight for approximately 3 hours. The reactor was restarted and the static was virtually eliminated. Following start up the hydroxylethyl alkylamine concentration was reduced to 18 ppm. Referring to FIG. 1, the reduction in static in the reactor is illustrated.

### Example 2

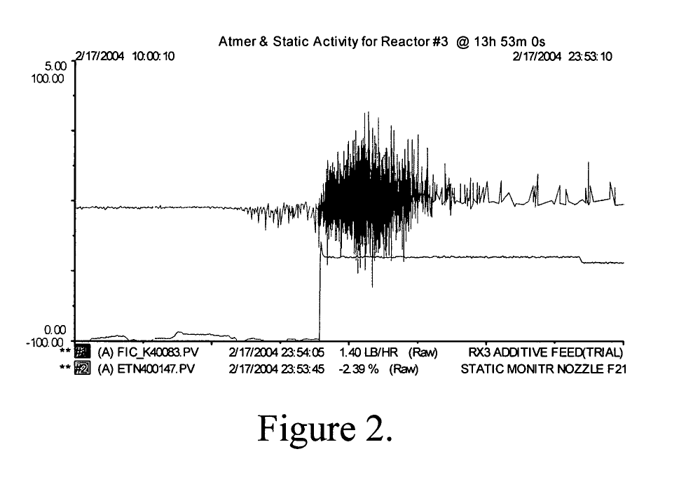

During the transition from homopolymer to random copolymer production, as ethylene was added into the reactor significant static levels were measured. These levels ranged from +/−50% of the targeted normal static level. It was suspected the cause of these static fluctuations was due to contamination in the ethylene stream. Hydroxylethyl alkylamine was added directly to the cycle gas pipe at a constant concentration of 30 ppm. Within two hours of addition, the static was brought under control. Referring to FIG. 2, the increase in static monitored at the transition from homopolymer to random copolymer and subsequent reduction obtained by practicing the current process are illustrated.

The antifouling properties of the antistatic agent also prevents non-static related buildup on the reactor interior, cycle gas piping and associated equipment in the cycle gas loop. The hydroxyethyl alkylamine deactivates the surface sites of the catalyst. This prevents entrained fines from continuing to react in the circulating gas, thus preventing fouling. According to an embodiment of the current invention, to prevent fouling, the hydroxyethyl alkylamine can be fed continuously at a low dosage of 1-5 ppm, or fed when the reaction is stopped either by injection of a kill agent, or by stopping catalyst injection. When fed while the reaction is being stopped, the antistatic agent is fed at 30 ppm by weight until the reaction has ceased. Again, the antistatic agent can be injected neat or with a carrier and can be injected at a number of points in the circulating gas line.

1. A method for regulating static charge in a fluidized bed polymerization reactor, the method comprising:
establishing an acceptable static charge level for a fluidized bed polymerization reactor;
monitoring the static charge level in said polymerization reactor;
adding an anti-static agent at a first concentration to said polymerization reactor in response to a static charge measurement outside said acceptable level to return said static measurement to said acceptable level; and
adding said anti-static agent at a second concentration to stabilize said static measurement at said acceptable level.

2. The method according to claim 1, wherein said first concentration is up to about 100 ppm based on the polymer production of said polymerization reactor.

3. The method according to claim 2, wherein said second concentration is less than 20 ppm based on the polymer production of said polymerization reactor.

4. The method according to claim 1, wherein said anti-static agent is added to the circulating gas line of said polymerization reactor using a feed stream to the polymerization reactor as a carrier stream.

5. The method according to claim 4, wherein said carrier stream is a propylene feed stream to said polymerization reactor.

6. The method according to claim 1, wherein said monitoring is performed by at least one static probe located on said polymerization reactor in the fluidized bed.

7. The method according to claim 6, wherein said monitoring is performed by two static probes spaced about 2 to 3 feet vertically apart in the same reactor plane.

8. The method according to claim 1, wherein said anti-static agent is a hydroxylethyl alkylamine or derivatives of hydroxyethyl alkylamine.

9. A method for regulating static charge in a fluidized bed polymerization reactor, the method comprising:
establishing an acceptable static charge level for a fluidized bed polymerization reactor;
monitoring the static charge level in said reactor with two static probes located on a straight wall of said polymerization reactor, said probes being spaced about 2 to 3 feet vertically apart;
adding a hydroxylethyl alkylamine to a propylene feed stream of said polymerization reactor at a concentration of up to 100 ppm based on the polymer production of said polymerization reactor in response to a static charge measurement outside said acceptable level, to return said static measurement to said acceptable level; and
adding said hydroxylethyl alkylamine to said propylene stream at a concentration about 10 ppm based on the polymer production of said polymerization reactor to stabilize said static measurement at said acceptable level.
